(19) United States
(12) Patent Application Publication
(10) Pub. No.: US 2005/0177079 A1
(43) Pub. Date: Aug. 11, 2005

(54) Water flow circulation device for a tooth flush machine

(76) Inventor: Kun-Chuan Pan, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/776,055

(22) Filed: Feb. 10, 2004

(51) Int. Cl. A61H 9/00; A61H 13/00

(52) U.S. Cl. 601/162; 601/160

(57) ABSTRACT

A water flow circulation device includes a main body, a cover, a plug, an inlet valve, an outlet valve, a piston, and a pressure release valve. The water flow circulation device has a pressure release effect. Thus, the pressure release valve can efficiently release the higher pressure applied on the hose when the water stops flowing outward from the nozzle, thereby preventing the hose from being loosened due to an excessive hydraulic pressure, and thereby increasing the lifetime of the hose.

### BACKGROUND OF THE INVENTION

1. Field of the Invention

The present invention relates to a water flow circulation device for a tooth flush machine, and more particularly to a water flow circulation device having a pressure release effect.

2. Description of the Related Art

A conventional pressure release valve of a tooth flush machine disclosed in U.S. Pat. No. 5,993,402 is shown in FIG. 8 and comprises a water inlet 2A having a rear end provided with a water inlet valve 8A and a pressure release valve 13A, a water outlet 3A having a front end provided with a water outlet valve 21A, and a switch valve 25A for controlling the water flow of a hose 250A. When the water pump 1A drives the piston 4A to move in the cylinder 5A reciprocatingly, the piston 4A is moved backward (as indicated by the arrow 6A) in the cylinder 5A to produce an attractive effect, and is moved forward (as indicated by the arrow 7A) in the cylinder 5A to produce a thrust effect.

When the piston 4A is moved backward in the cylinder 5A to produce an attractive effect, the water inlet valve 8A and the pressure release valve 13A are moved backward to detach from the water inlet 2A, thereby introducing the water into the water inlet 2A. At this time, the water outlet valve 21A is closed. When the piston 4A is moved forward in the cylinder 5A to produce a thrust effect, the water inlet valve 8A and the pressure release valve 13A are moved forward to interrupt the water inlet 2A, thereby stopping the water flow. At this time, the water outlet valve 21A is opened by the water pressure, so that the water flows through the water outlet 3A, the opened switch valve 25A and the hose 250A and is ejected outward from a nozzle (not shown) to achieve the tooth flush effect.

After the tooth flush action is accomplished, the switch valve 25A is closed to stop the water flowing from the nozzle. At this time, the piston 4A is moved in the cylinder 5A successively to produce an attractive effect and a thrust effect reciprocatingly. In such a manner, the water is gradually accumulated in the water pump 1A to form a higher pressure to overcome the elastic force of the elastic member 14A of the pressure release valve 13A so as to push away the ball 15A, thereby forming a circulation effect so as to release the water pressure.

However, the water inlet valve 8A and the pressure release valve 13A are commonly provided on the water inlet 2A. Thus, the water pressure is accumulated from the closed switch valve 25A through the water outlet valve 21A toward the pressure release valve 13A during the water pressure release process. In such a manner, the water pressure contained between the water outlet valve 21A and the closed switch valve 25A is accumulated and cannot be released during the water pressure release process, thereby forming a saturated water pressure to produce a greater load on the hose 250A, so that the hose 250A easily becomes loosened due to an excessive hydraulic pressure, thereby decreasing the lifetime of the hose 250A.

### SUMMARY OF THE INVENTION

The primary objective of the present invention is to provide a water flow circulation device having a pressure release effect.

Another objective of the present invention is to provide a water flow circulation device, wherein the pressure release valve can efficiently release the higher pressure applied on the hose when the water stops flowing outward from the nozzle, thereby preventing the hose from being loosened due to an excessive hydraulic pressure, and thereby increasing the lifetime of the hose.

In accordance with the present invention, there is provided a water flow circulation device, comprising:
a main body having an inside formed with a first chamber and a second chamber, and having a periphery formed with an inlet channel communicating with the first chamber and the second chamber and formed with a piston chamber communicating with the second chamber;
a cover mounted on a first end of the main body and having an inside formed with a first passage communicating with the first chamber of the main body and a second passage communicating with the second chamber of the main body, the cover having a periphery formed with a circulation channel communicating with the first passage and the second passage;
a piston movably mounted in the piston chamber of the main body; and
a pressure release valve mounted in the circulation channel of the cover to form a circulation effect between the cover and the main body so as to release a hydraulic pressure in the cover.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tooth flush machine in accordance with the preferred embodiment of the present invention;

FIG. 2 is an exploded perspective view of a water flow circulation device of the tooth flush machine in accordance with the preferred embodiment of the present invention;

FIG. 3 is a plan cross-sectional view of a main body of the water flow circulation device as shown in FIG. 2;

FIG. 4 is a plan cross-sectional view of a cover of the water flow circulation device as shown in FIG. 2;

FIG. 5 is a perspective view of a plug of the water flow circulation device as shown in FIG. 2;

FIG. 6 is a plan cross-sectional view of the plug as shown in FIG. 5;

FIG. 7 is a plan cross-sectional assembly view of the water flow circulation device as shown in FIG. 2; and

FIG. 8 is a plan cross-sectional view of a conventional tooth flush machine in accordance with the prior art.

### DETAILED DESCRIPTION OF THE INVENTION

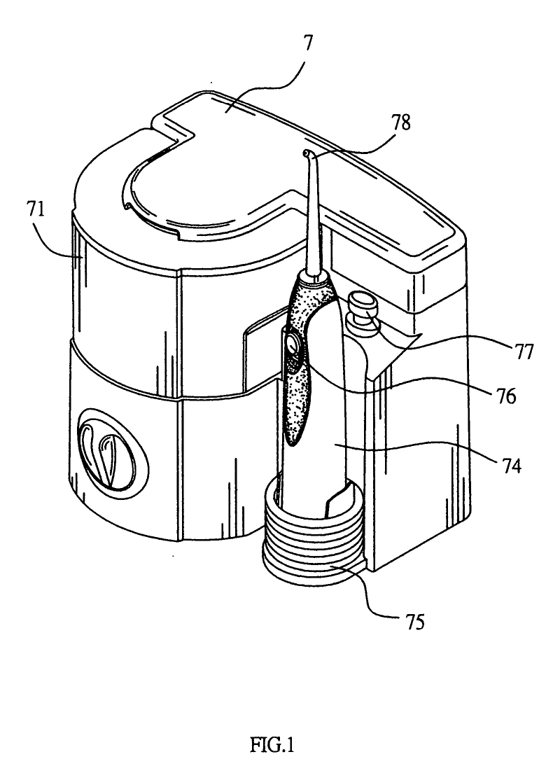

Referring to the drawings and initially to FIG. 1, a tooth flush machine in accordance with the preferred embodiment of the present invention comprises a main frame 7, a water tank 71 mounted on the main frame 7 and provided with a connecting tube 72, a handle 74 mounted on the main frame 7, a switch valve 76 mounted on the handle 74, a hose 75 having a first end mounted on a first end of the handle 74, a nozzle 78 mounted on a second end of the handle 74, a switch 77 mounted on the main frame 7, and a water flow circulation device 1 mounted in the main frame 7 and connected between the connecting tube 72 of the water tank 71 and the hose 75.

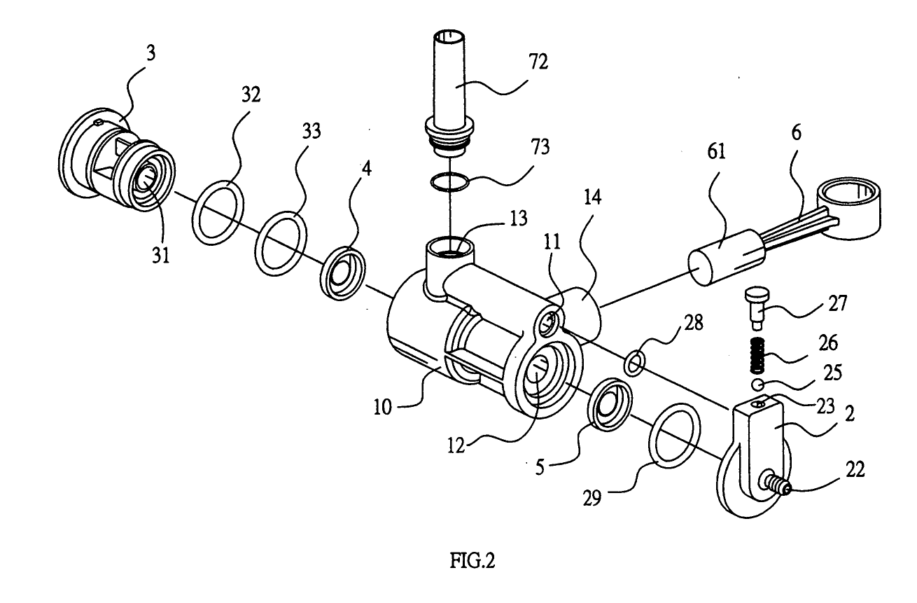

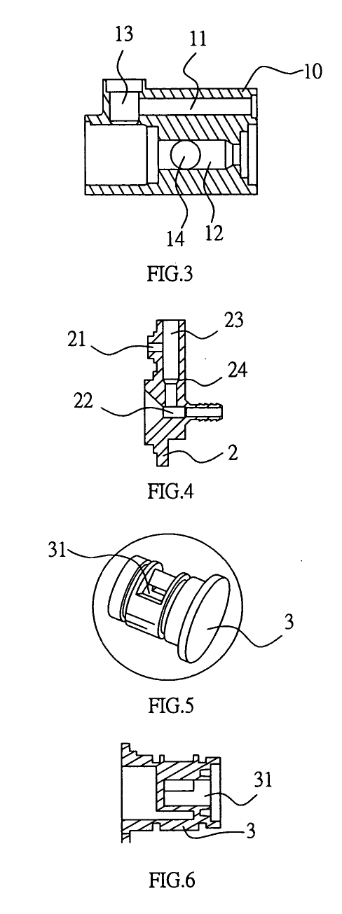

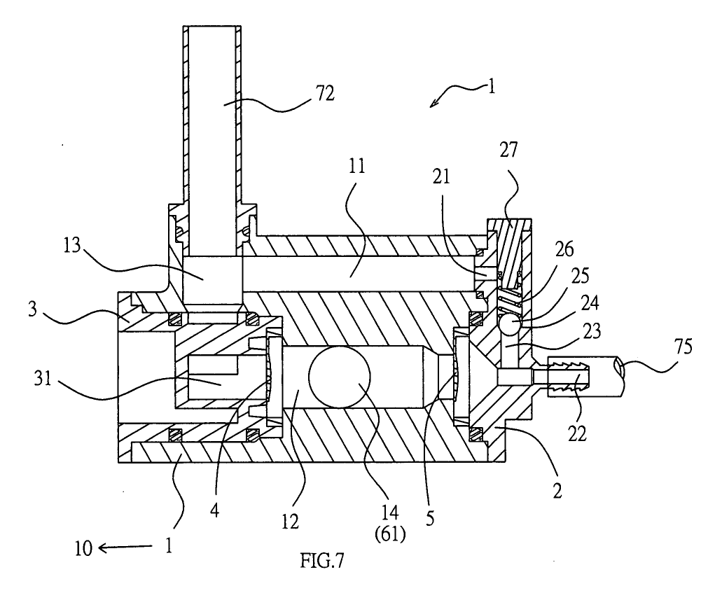

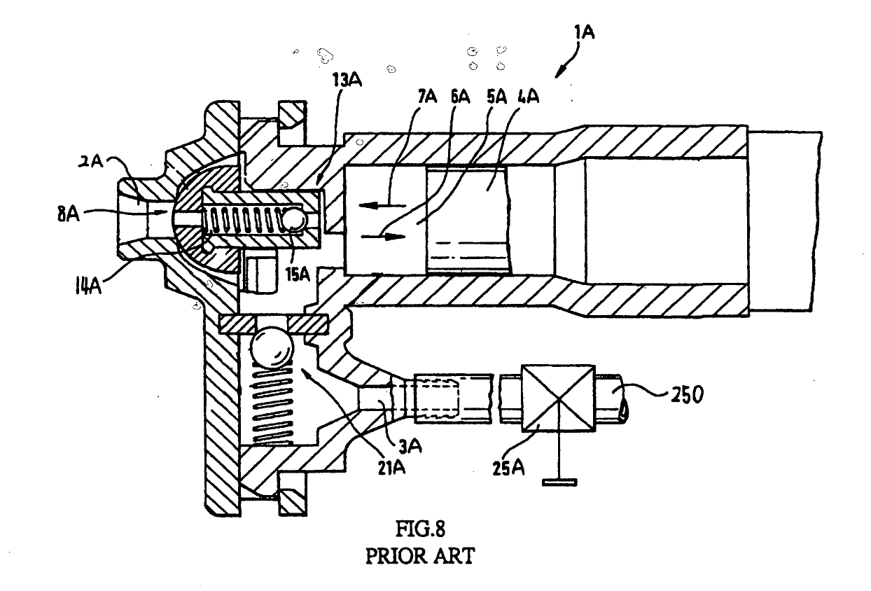

Referring to FIGS. 1-7, the water flow circulation device 1 in accordance with the preferred embodiment of the present invention comprises a main body 10, a cover 2, a plug 3, an inlet valve 4, an outlet valve 5, and a piston lever 6.

The main body 10 has an inside formed with a first chamber 11 and a second chamber 12, and has a periphery formed with an inlet channel 13 communicating with the first chamber 11 and the second chamber 12 and formed with a piston chamber 14 communicating with the second chamber 12. The piston chamber 14 of the main body 10 is vertical to the second chamber 12. The connecting tube 72 of the water tank 71 has a distal end mounted in the inlet channel 13 of the main body 10, and an O-ring 73 is mounted between the connecting tube 72 of the water tank 71 and the inlet channel 13 of the main body 10.

The cover 2 is mounted on a first end of the main body 10 by two O-rings 28 and 29 and has an inside formed with a first passage 21 communicating with the first chamber 11 of the main body 10 and a second passage 22 communicating with the second chamber 12 of the main body 10, and has a periphery formed with a circulation channel 23 communicating with the first passage 21 and the second passage 22. The hose 75 has a second end mounted on the second passage 22 of the cover 2.

The water flow circulation device 1 further comprises a pressure release valve mounted in the circulation channel 23 of the cover 2 to form a circulation effect between the cover 2 and the main body 10 so as to release the hydraulic pressure in the cover 2. The circulation channel 23 of the cover 2 is formed with a stepped catch portion 24 located between the first passage 21 and the second passage 22, and the pressure release valve includes an anti-reverse member 25 movably mounted on the catch portion 24 of the circulation channel 23, a stop 27 inserted into the circulation channel 23 of the cover 2, and an elastic member 26 mounted in the circulation channel 23 of the cover 2 and urged between the stop 27 and the anti-reverse member 25 to retain the anti-reverse member 25 on the catch portion 24 of the circulation channel 23.

The plug 3 is mounted on a second end of the main body 10 by two O-rings 32 and 33 and has an inside formed with a substantially L-shaped flow channel 31 communicating with the second chamber 12 and the inlet channel 13 of the main body 10.

The inlet valve 4 is mounted between the flow channel 31 of the plug 3 and the second chamber 12 of the main body 10.

The outlet valve 5 is mounted between the second chamber 12 of the main body 10 and the second passage 22 of the cover 2.

The piston lever 6 has a first end formed with a piston 61 movably mounted in the piston chamber 14 of the main body 10 and a second end mounted on a cam (not shown) of a motor (not shown) mounted in the main frame 7.

Thus, the cam of the motor drives the piston lever 6 to move reciprocally, so that the piston 61 is moved into the piston chamber 14 of the main body 10 to produce a thrust effect and moved outward from the piston chamber 14 of the main body 10 to produce an attractive effect.

In operation, the switch valve 76 mounted on the handle 74 is opened, and the switch 77 is pressed to start the motor to drive the piston lever 6 to move reciprocally, so that the piston 61 is moved in the piston chamber 14 of the main body 10.

When the piston 61 is moved outward from the piston chamber 14 of the main body 10 to produce an attractive effect, the inlet valve 4 is opened and the outlet valve 5 is closed. When the piston 61 is moved into the piston chamber 14 of the main body 10 to produce a thrust effect, the inlet valve 4 is closed and the outlet valve 5 is opened.

In such a manner, when the piston 61 is moved outward from the piston chamber 14 of the main body 10 to produce an attractive effect, the water contained in the water tank 71 flows through the connecting tube 72, the inlet channel 13 of the main body 10, the flow channel 31 of the plug 3 and the inlet valve 4 into the second chamber 12 of the main body 10, and when the piston 61 is moved into the piston chamber 14 of the main body 10 to produce a thrust effect, the water contained in the second chamber 12 of the main body 10 flows through the outlet valve 5, the second passage 22 of the cover 2, the hose 75 and the handle 74 and is ejected outward from the nozzle 78 of the handle 74 to achieve the tooth flush effect.

After the tooth flush action is accomplished, the switch valve 76 mounted on the handle 74 is closed to stop the water flow. At this time, the motor continues to drive the piston lever 6 to move reciprocally, so that the piston 61 is moved in the piston chamber 14 of the main body 10 successively to produce an attractive effect and a thrust effect reciprocatingly.

In such a manner, the water is gradually accumulated in the hose 75 and the second chamber 12 of the main body 10 to form a higher pressure to overcome the elastic force of the elastic member 26 so as to detach the anti-reverse member 25 from the catch portion 24 of the circulation channel 23, thereby forming an open state, so that the water contained in the hose 75 and the second chamber 12 of the main body 10 flows through the circulation channel 23 of the cover 2, the first passage 21 of the cover 2, the first chamber 11 of the main body 10, the inlet channel 13 of the main body 10 and the connecting tube 72, and flows back into the water tank 71 to form a circulation effect.

Accordingly, the pressure release valve can efficiently release the higher pressure applied on the hose 75 when the water stops flowing outward from the nozzle 78, thereby preventing the hose 75 from being loosened due to an excessive hydraulic pressure, and thereby increasing the lifetime of the hose 75.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A water flow circulation device, comprising:
a main body having an inside formed with a first chamber and a second chamber, and having a periphery formed with an inlet channel communicating with the first chamber and the second chamber and formed with a piston chamber communicating with the second chamber;
a cover mounted on a first end of the main body and having an inside formed with a first passage communicating with the first chamber of the main body and a second passage communicating with the second chamber of the main body, the cover having a periphery formed with a circulation channel communicating with the first passage and the second passage;
a piston movably mounted in the piston chamber of the main body; and
a pressure release valve mounted in the circulation channel of the cover to form a circulation effect between the cover and the main body so as to release a hydraulic pressure in the cover.

2. The water flow circulation device in accordance with claim 1, wherein the circulation channel of the cover is formed with a stepped catch portion located between the first passage and the second passage, and the pressure release valve includes an anti-reverse member movably mounted on the catch portion of the circulation channel.

3. The water flow circulation device in accordance with claim 2, wherein the pressure release valve further includes a stop inserted into the circulation channel of the cover, and an elastic member mounted in the circulation channel of the cover and urged between the stop and the anti-reverse member to detachably retain the anti-reverse member on the catch portion of the circulation channel.

4. The water flow circulation device in accordance with claim 2, wherein the anti-reverse member is movable between a first position where the anti-reverse member is rested on the catch portion of the circulation channel to interrupt connection between the first passage and the second passage, and a second position where the anti-reverse member is detached from the catch portion of the circulation channel to connect the first passage to the second passage through the circulation channel.

5. The water flow circulation device in accordance with claim 1, further comprising a plug mounted on a second end of the main body and having an inside formed with a flow channel communicating with the second chamber and the inlet channel of the main body.

6. The water flow circulation device in accordance with claim 5 wherein the flow channel of the plug is substantially L-shaped.

7. The water flow circulation device in accordance with claim 5, further comprising an inlet valve mounted between the flow channel of the plug and the second chamber of the main body.

8. The water flow circulation device in accordance with claim 1, further comprising an outlet valve mounted between the second chamber of the main body and the second passage of the cover.

9. The water flow circulation device in accordance with claim 1, wherein the piston is mounted on a piston lever.

10. The water flow circulation device in accordance with claim 1, wherein the piston chamber of the main body is vertical to the second chamber.

11. The water flow circulation device in accordance with claim 1, wherein the piston is moved into the piston chamber of the main body to produce a thrust effect.

12. The water flow circulation device in accordance with claim 11, further comprising an inlet valve and an outlet valve each mounted in the second chamber of the main body, wherein when the piston is moved outward from the piston chamber of the main body to produce an attractive effect, the inlet valve is opened and the outlet valve is closed.

13. The water flow circulation device in accordance with claim 1, wherein the piston is moved outward from the piston chamber of the main body to produce an attractive effect.

14. The water flow circulation device in accordance with claim 13, further comprising an inlet valve and an outlet valve each mounted in the second chamber of the main body, wherein when the piston is moved into the piston chamber of the main body to produce a thrust effect, the inlet valve is closed and the outlet valve is opened.
